(19) United States
(12) Patent Application Publication
(10) Pub. No.: US 2016/0219963 A1
(43) Pub. Date: Aug. 4, 2016

(54) Protective Hood

(71) Applicants: Richard Dale Eklof, Lehi, UT (US); Kenneth Ernest Eklof, Elk Ridge, UT (US)

(72) Inventors: Richard Dale Eklof, Lehi, UT (US); Kenneth Ernest Eklof, Elk Ridge, UT (US)

(73) Assignees: Kenneth Ernest Eklof, Elk Ridge, UT (US); Richard Dale Eklof, Lehi, UT (US)

(21) Appl. No.: 14/613,626

(22) Filed: Feb. 4, 2015

(51) Int. Cl. A42B 1/24; G02C 11/00; G02C 7/12; G02C 7/10; A42B 3/00; G02C 3/02

(52) U.S. Cl. CPC A42B 1/247; A42B 3/00; G02C 3/02; G02C 7/12; G02C 7/10; G02C 11/12

(57) ABSTRACT

A protective hood may comprise a piece of fabric formed to completely cover a user's head and neck, an eye hole defined in the hood, and a pair of glasses coupled to the interior edges of the eye hole. A garment may comprise a piece of fabric forming a hood to be placed over a head of a user, an opening defined in the hood at a position of the user's eyes, and an internal frame coupled to the edge of the opening comprising a nose piece to rest on the user's nose, a pair of earpieces to rest on the user's ears and a transparent medium through which the user may see.

### BACKGROUND

Clothing may be worn to serve a number of purposes. It may be worn to protect the user from natural pests and to enhance safety during hazardous activities. Additionally, clothing may be worn to protect the wearer from extreme cold and hot weather.

### BRIEF DESCRIPTION OF THE DRAWINGS

The accompanying drawings illustrate various examples of the principles described herein and are a part of the specification. The examples do not limit the scope of the claims.

FIG. 1 is a diagram of a hood according to one example of principles described herein.

FIG. 2 is a diagram of a hood according to another example of principles described herein.

FIG. 3 is a diagram of a side view of the hood shown in FIG. 2 according to another example of principles described herein.

FIG. 4 is a diagram of a hood according to another example of principles described herein.

FIGS. 5A-5C each show an isometric view of the interface between the eye holes and the glasses according to three examples of the principles described herein.

FIG. 6 is a block diagram showing a method of forming a hood according to one example of the principles described herein.

Throughout the drawings, identical reference numbers designate similar, but not necessarily identical, elements.

### DETAILED DESCRIPTION

Many types of fabric have been created to fit many types of situations. The safety and comfort of the wearer is a concern for some users. Usually a person will choose a garment based on the protection it provides while wearing, the look and style of the garment, or the safety the garment may provide while wearing it. However, a user may have to choose between comfort, style, and safety because few garments offer such features all at the same time.

The present specification describes a hood to be worn by a user in various environmental conditions. The hood may completely cover a user's head and neck when worn. The hood may have a hole defined therein at a location where a user's eyes would be. The hole may be defined in such a way to fit a pair of glasses therein. The interior edge of the hole may be coupled to the exterior of the glasses such that the hood is sealed off from environmental irritants such as sand, dust, bugs, wind, heat, and cold, among others.

In some examples, the hood may be worn in hazardous environments such as a construction site without inhibiting the user's ability to be alert and aware of his or her surroundings.

The present specification describes a protective hood comprising a piece of fabric formed to completely cover a user's head and neck, an eye hole defined in the hood, and a pair of glasses coupled to the interior edges of the eye hole.

The present specification also describes a garment comprising a piece of fabric forming a hood to be placed over a head of a user, an opening defined in the hood at a position of the user's eyes, and an internal frame coupled to the edge of the opening comprising a nose piece to rest on the user's nose, a pair of earpieces to rest on the user's ears and a transparent medium through which the user may see.

The present specification further describes a method of forming a hood, comprising forming a piece of fabric into a conical domed shape sufficient to fit entirely over a user's head and neck, defining an eye hole in a portion of the fabric to allow a user to view out of the fabric while wearing the hood, and coupling a number of outer edges of a pair of glasses to the interior edges of the eye hole.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “environmental irritant” is meant to be understood broadly as any object originating in the human environment that irritates a human in some way. Some examples may include sand, dust, bugs, wind, heat, and cold, among others.

Additionally, in the present specification and in the appended claims, the term “glasses” is meant to be understood as eyewear worn over the eyes of a person comprising a transparent medium through which a user may see through. In one example, the glasses may be a pair of eyeglasses including a pair of prescription lenses. In another example, the glasses may be a pair of goggles. In yet another example, the transparent medium may include two individual pieces of transparent medium; one for each eye. In still another example, the transparent medium may include a single piece of transparent medium.

Even still further, as used in the present specification and in the appended claims, the term “a number of” or similar language is meant to be understood broadly as any positive number comprising 1 to infinity; zero not being a number, but the absence of a number.

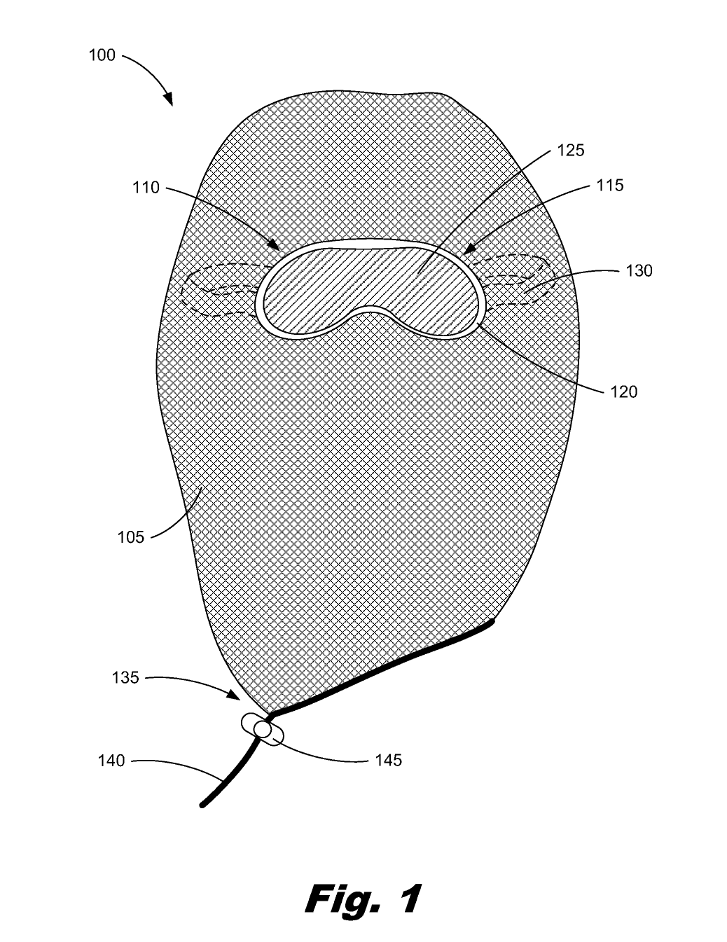

FIG. 1 is a diagram of a hood (100) according to one example of principles described herein. The hood (100) may include a piece of fabric (105) into which an eye hole (110) is defined. The fabric (105) may include any fabric capable of preventing environmental irritants out of the hood (100). In one example, the fabric (105) may be netting. In this example, the netting may prevent insects from entering the hood (100) while allowing the wearer of the hood (100) to breathe. Additionally, the netting may allow heat to escape quickly from the surface of the user's head and neck keeping the wearer cool in relatively extreme temperatures.

In another example, the fabric (105) may be made of a heat retaining material such as cotton or wool. In this example, the hood (100) may be worn by the user during activities being conducted in relatively extreme colder conditions such as skiing or ice fishing. In this example, additionally types of fabric (105) may be used such that heat from the user is maintained within the hood (100).

The eye hole (105) may be defined in the portion of fabric (105) where a user's eyes may be when the hood (100) is being worn by the user. The eye hole, (105) may be defined by cutting the portion of fabric (105) away from the hood (100). In one example, the edge of the eye hole (110) defined in the hood (100) may be serger stitched such that the fabric (105) defining the edge of the eye hole (110) does not fray or unravel. The serger stitching may also provide a surface onto which a pair of glasses may be coupled thereto.

The hood (100) may further include a pair of glasses (115) coupled to the edge of the eye hole (110) defined in the hood (100). The glasses (115) may include any type of eyewear through which a user may see through. FIG. 1 shows a pair of goggles as the pair of glasses (1115). However, this is meant only as an example and the present specification contemplates the use of any type of glasses. The glasses (115) may further include a frame (120) to which the edge of the eye hole (110) is coupled to. In one example, the edge of the eyehole (110) is coupled to the frame (120) of the glasses permanently using, for example, glue. In another example, a number of fasteners such as snaps may be used to couple the edge of the eye hole (110) and the hood (100) to the frame (120) and glasses (115). In this example, the glasses (115) may be switched out for another pair of glasses (115) if the first pair is broken or if the second pair includes features not present in the first pair such as a polarized transparent medium (125).

The glasses (115) may further include a transparent medium (125). The transparent medium (125) may be fit into the frame (120) and allow a user to see through and out of the hood (100). The transparent medium (125) may be any type of medium through which the user may see and may further include a number of tints, colors, and light diffracting characteristics. In one example, the transparent medium (125) may include a lens or lenses which allow a user to see more clearly when wearing them. In this example, the lenses may be prescription lenses. In another example, the lenses may be polarized lenses such that polarized light is not passed through the glasses (115) and to the user's eyes. In yet another example, a colored tint may be added to the lenses to further shade a user's eyes from bright light.

FIG. 1 further shows a head strap (130) shown in ghost and coupled to the frame (120) of the glasses (115). The head strap (130) may be coupled to the frame (120) such that they remain inside the hood (100). During use, the user may wrap the head strap (130) around his or her head in order to secure the glasses (115) to the user's face at the correct location. In one example, the head strap (130) may be elastic to provide some tension against the head but also be resilient and comfortable to the user.

The hood (100) may further include a tightening device (135) to tighten the hood (100) to the user's face or neck. In the example shown in FIG. 1, the tightening device (135) may be a string (140) and cinch (145). In this example, the string (140) may be passed through a fold in the bottom of the hood (100) and have an amount of string (140) allowed to pass out of the fold. The amount of string passing out of the fold may be passed through the cinch (145). During use, a user may pull the amount of string (140) through the cinch (145) limiting the amount of string (140) in the fold thereby cinching the fabric (105) of the hood (100) towards the user's face and/or neck. Although, FIG. 1 shows a string (140) and cinch (145) as the tightening device (135), any type of tightening device (135) may be used to tighten the hood (100) to the user's neck and face and the present specification contemplates the use of those other tightening devices (135).

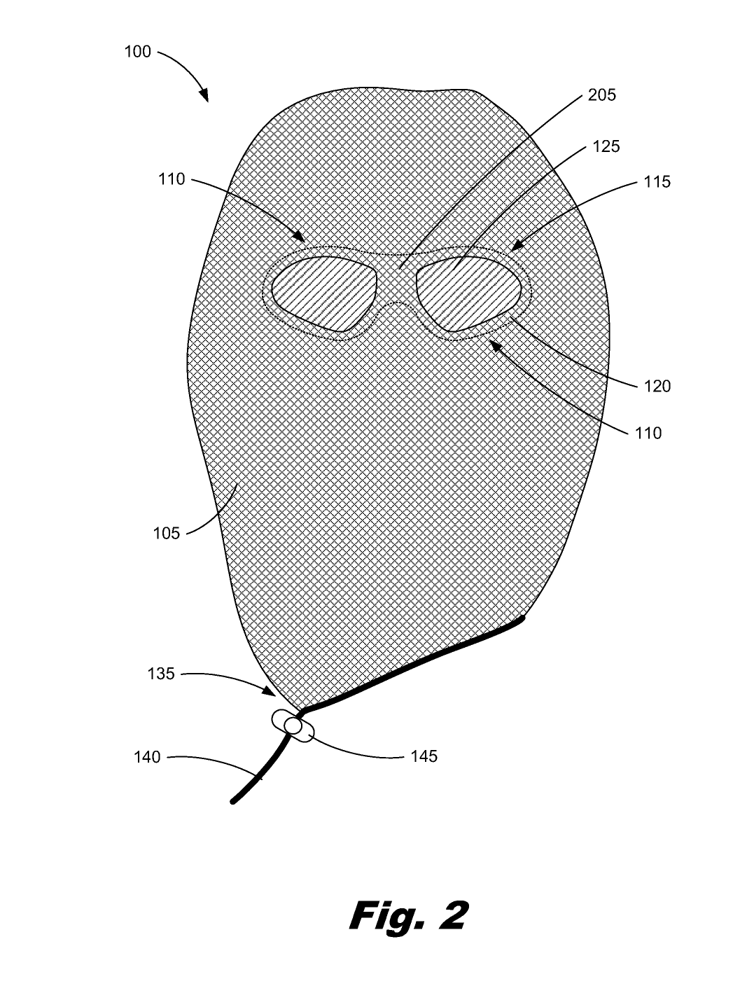

FIG. 2 is a diagram of a hood (100) according to another example of principles described herein. FIG. 2 shows a hood (100) made of fabric (105) as similarly described above in connection with FIG. 1. In this example, two eye holes (110) may be cut out of the hood (100) fabric (105) such that a pair of glasses (115) having two separate pieces of transparent medium (125) can be associated with those eye holes (110). In this example, the glasses (115) are sunglasses that comprise two separate lenses. The sunglasses in this example provide a bridge (205) in the frame (120) that separates the two lenses. The bridge (205) may act as additional surface area onto which the edges of the eye holes (110) may be coupled to via, for example, a glue.

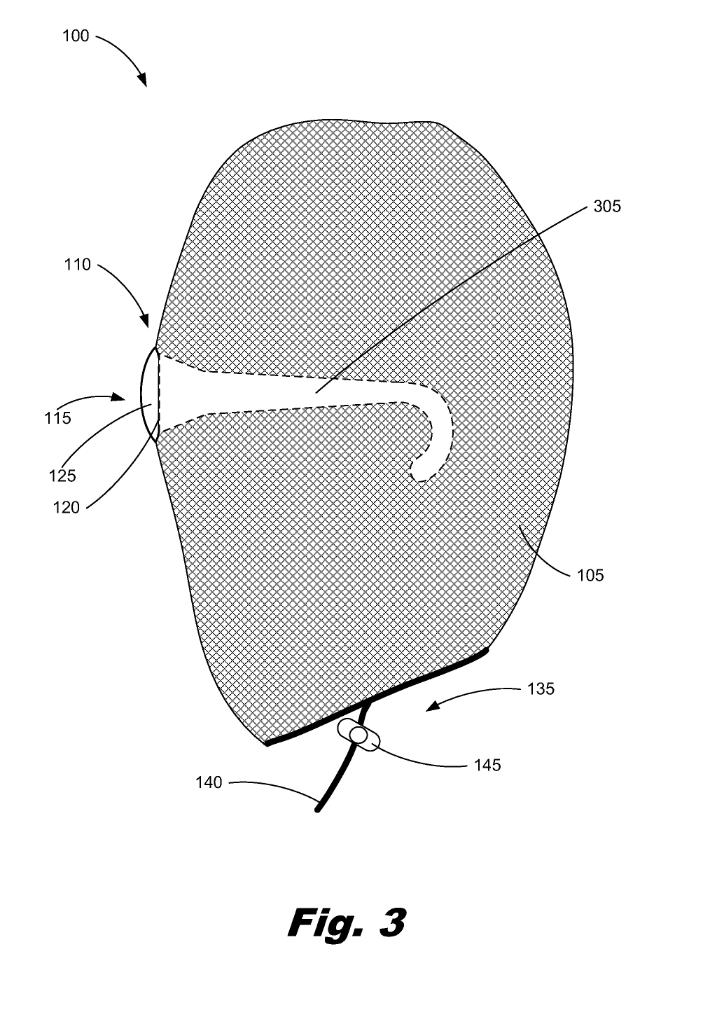

The glasses (115) shown in FIG. 2 may also include a number of internal temples attached to the frame (120) of the glasses (115). The internal frame may be internal to the hood (100) may fit onto the user's ears similar to an eyeglass frame for eyeglasses. FIG. 3 is a diagram of a side view of the hood (100) shown in FIG. 2 according to one example of the principles described herein. The side view shows the left side of the hood (100). In ghost, an internal temple (305) is shown attached to the frame (120) of the glasses (115) as described in connection with FIG. 2. In this example, the temple (305) is a skull temple in that the terminal end of the temple (305) bends down to form a hook around a user's ear when being worn. A temple (305) may also be attached to the right side of the frame (120) of the glasses (115). The temples (305) may help place the glasses (115) close to the user's face and secure the glasses (115) in place while being worn. Each temple may be inside the hood (100) to prevent any discomfort by the user and to prevent any environmental irritants from entering the hood (100).

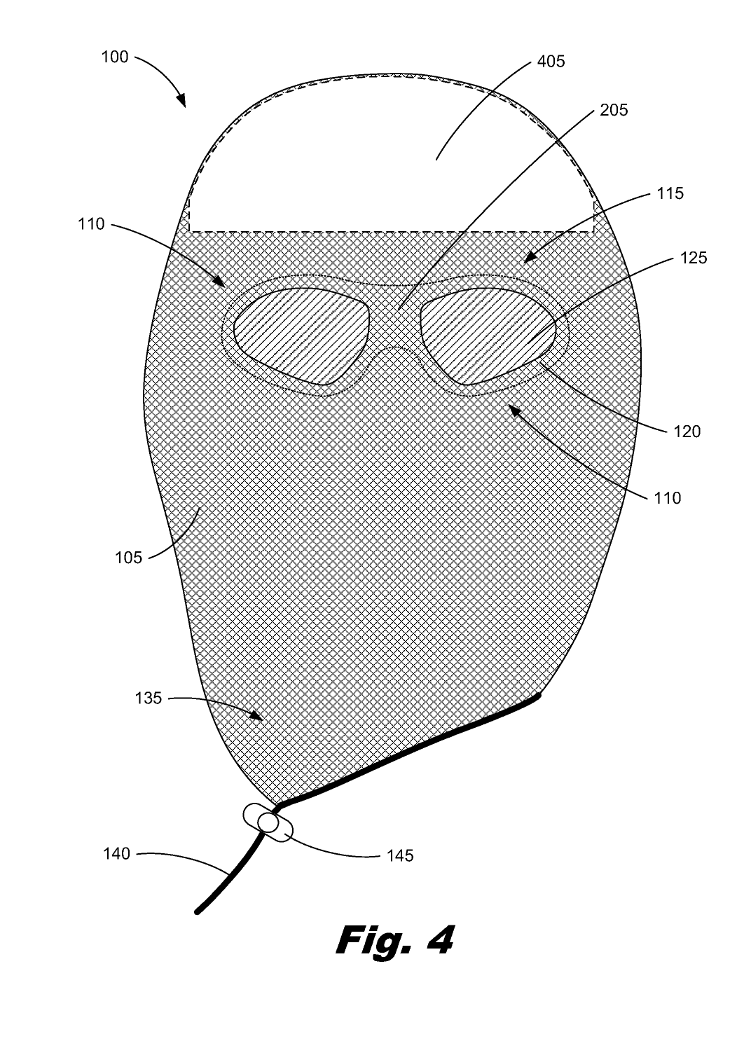

FIG. 4 is a diagram of a hood (100) according to another example of principles described herein. In this example, the hood (100) may comprise those features previous described in connection with FIGS. 1 and 2 and may further comprise a cap (405) fitted into the interior surface of the hood (100). The cap (405) may comprise any resilient or rigid material to which the hood (100) or a portion of the hood (100) may be coupled. The cap (405) may serve to help hold the hood (100) in place while the user is wearing the hood (100). In one example, the cap (405) may include a brim extending out from cap (405) and away from the user's head while the hood (100) is being worn. In this example, the brim may extend far enough away from the user's head to prevent the fabric (105) of the hood from touching the surface of the user's skin. In one example, the brim may extend out a relatively small distance such that the fabric (105) of the hood does not touch the surface of the user's skin but so that the user may see above his or her head with a relatively unobstructed view. This may provide the best comfort for a user in relatively hot conditions while still allowing a user to be aware of potential dangers above his or her head.

In one example, the cap (405) may be permanently coupled to the interior surface of the hood (100) via a glue. In another example, the cap (405) may be selectively coupled to the interior surface of the hood (100) using a number of snaps, velcro, magnets, and hooks and loops, among others. Selectively coupling the cap (405) to the hood (100) may allow a user to swap out different types of caps (405) within the hood (100) based on how and where the user intends to use the hood.

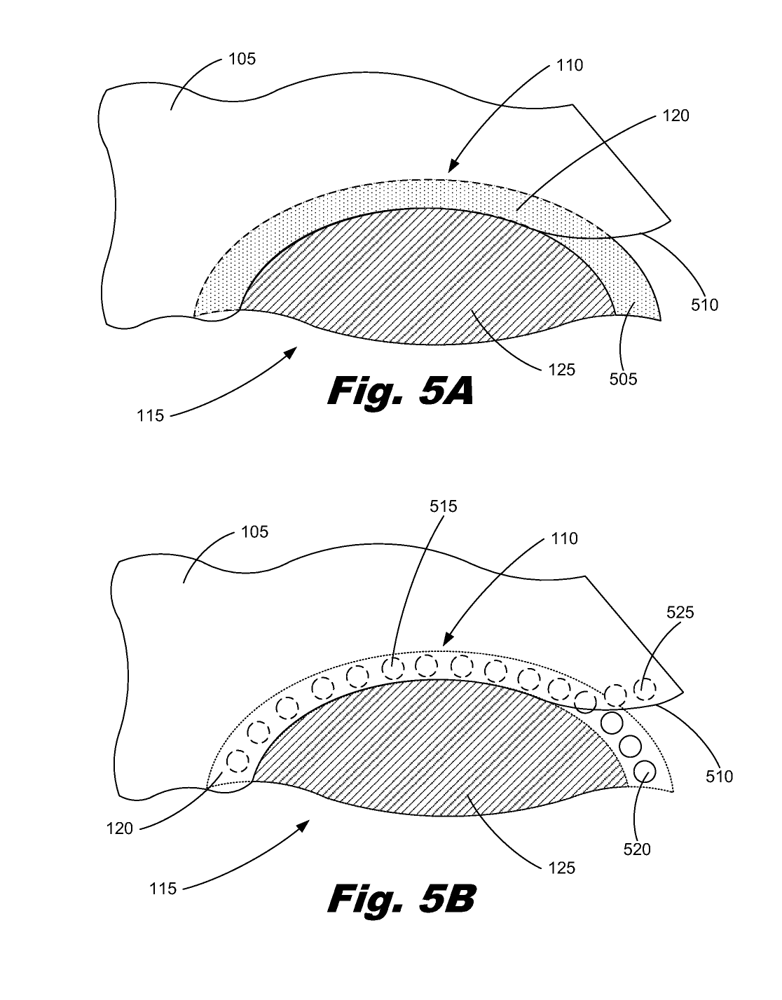

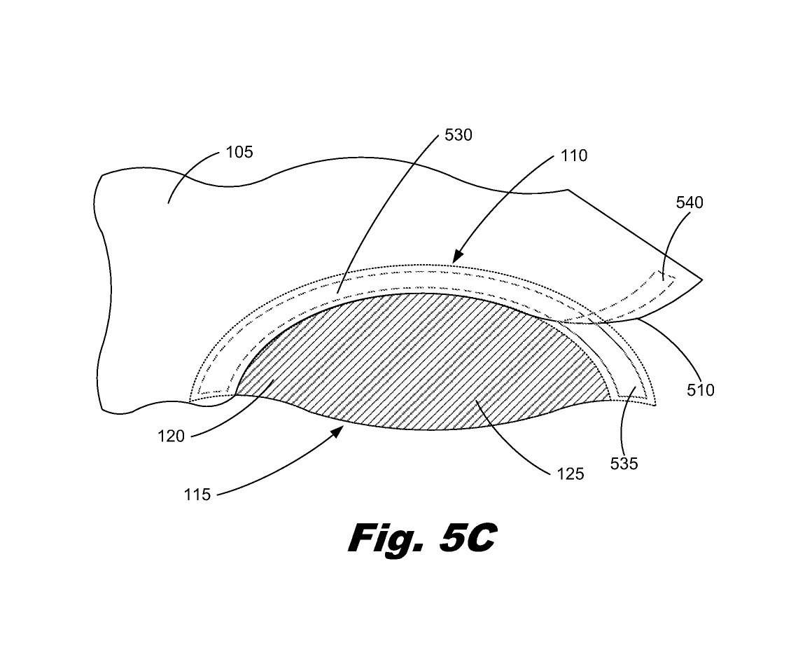

FIGS. 5A-5C each show an isometric view of the interface between the eye holes (110) and the glasses (115) according to three examples of the principles described herein. As described above, the eye holes (110) may be coupled to the glasses (115) using a number of permanent and temporary coupling devices and methods. FIG. 5A shows an isometric view of the interface between the eye holes (110) and the glasses (115) where a glue (505) is used as a permanent method to adhere the fabric (105) of the hood (100) near the eye holes (110) to, for example, the frame (120) of the glasses (115). In the example shown in FIG. 5A, a layer of glue (505) may be applied to the frame (120) and an interior edge (510) of the eyehole (110) may be placed over the layer of glue (505). The layer of glue (505) may cure so as to permanently affix the hood (100) to the glasses (115).

FIG. 5B shows an isometric view of the interface between the eye holes (110) and the glasses (115) where a number of snaps (515) are used to selectively couple the eye holes (110) to, for example, the frame (120) of the glasses (115). The snaps (515) may comprise a female (520) and a male (525) part that when pushed together form a tight fit between them. Although FIG. 5B shows the female part of the snap (515) coupled to the frame (120), the male part (525) may be coupled to the frame (120) without going beyond the scope of this description. The snaps (515) may selectively couple the glasses (115) to the hood (100) such that the glasses (115) may be removed from the hood (100) and replaced with another pair.

FIG. 5C shows an isometric view of the interface between the eye holes (110) and the glasses (115) where velcro (530) is used to selectively couple the eye holes (110) to, for example, the frame (120) of the glasses (115). A first half (535) of the velcro (530) may be coupled to the frame (120) of the glasses (115) while the second and mating half (540) of the velcro (530) is coupled to the edge (510) of the eye hole (110) of the hood (100). The velcro (530) may selectively couple the glasses (115) to the hood (100) such that the glasses (115) may be removed from the hood (100) and replaced with another pair.

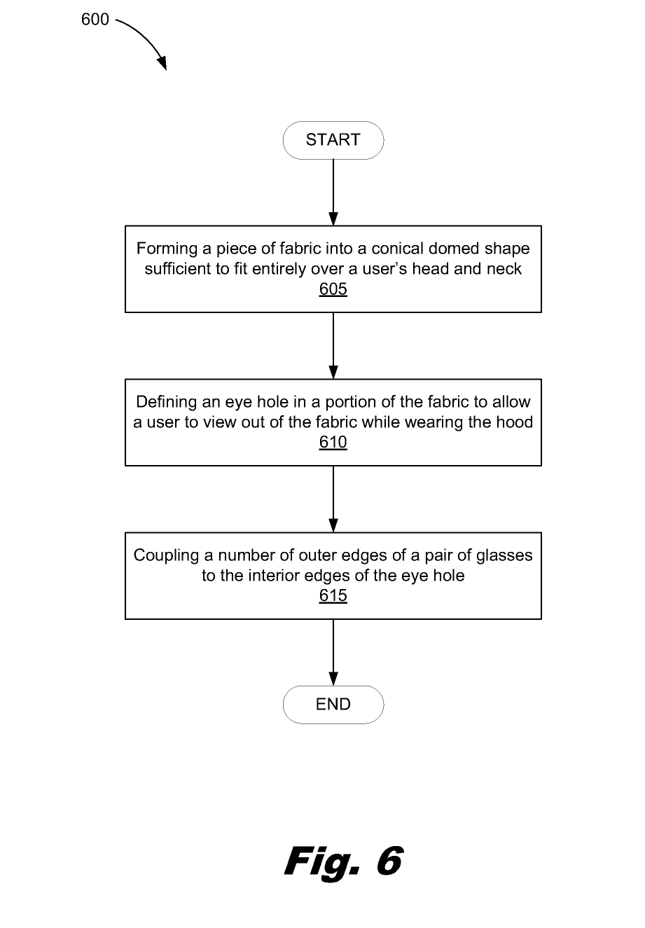

FIG. 6 is a block diagram showing a method (600) of forming a hood according to one example of the principles described herein. The method (600) may begin with forming (605) a piece of fabric (105) into a conical domed shape sufficient to fit entirely over a user's head and neck. As described above, the fabric (105) may be made of a number of different materials such as wool, netting, and cotton, among others.

The method (600) may continue with defining (610) an eye hole (110) in a portion of the fabric (105) to allow a user to view out of the fabric (105) while wearing the hood (100). The eye holes (110) may be defined by cutting away a portion of the fabric (105) away from the rest of the fabric (105) that has been shaped into the conical domed shape. Although FIG. 6 shows this process occurring after the conical domed shape has been formed, any of the processes in this method (600) may be completed in any of a number of various orders and the present specification contemplates such alternative methods.

The method (600) may further continue with coupling (615) a number of outer edges of a pair of glasses (115) to the interior edges (510) of the eye hole (110). As described above, the coupling (615) of the pair of glasses (115) to the interior edges (510) of the eye hole (110) may be permanent or temporary based on the process used to couple the two together. Although the present specification describes specific examples of coupling the pair of glasses (115) to the interior edges (510) of the eye hole (110), these examples are not meant to be limiting. Consequently, the present specification contemplates the use of any type of permanent or temporary method of coupling the pair of glasses (115) to the interior edges (510) of the eye hole (110).

The specification and figures describe a garment such as a hood that prevents environmental irritants from entering the hood while the user is wearing it. This hood may have a number of advantages. In one example, the hood may prevent insects from irritating or biting a user's skin while the user is wearing the hood. In another example, the hood may be made of a heat retaining material such that the user may wear the hood while in relatively cold conditions. In all examples, the hood may also provide an unobstructed view for the user such that environmental dangers can be seen and avoided. In one example, the hood may be used at, for example, a construction site. In this scenario, insects may be repelled while the user may be able to see objects over his or her head or around the user that can cause serious bodily injury to the user. In some examples, the hood may also allow the user to switch the type of glasses used in the hood such as from a prescription pair of eyeglasses to a pair of sunglasses. Storage of the hood is also relatively easier because the glasses could be wrapped with the fabric protecting the glasses themselves and placed in an eyeglass case or some relatively small case.

The preceding description has been presented to illustrate and describe examples of the principles described. This description is not intended to be exhaustive or to limit these principles to any precise form disclosed. Many modifications and variations are possible in light of the above teaching.

What is claimed is:

1. A garment comprising:
a piece of fabric forming a hood to be placed over a head of a user;
an opening defined in the hood at a position of the user's eyes;
an internal frame coupled to the edge of the opening comprising a nose piece to rest on the user's nose, a pair of earpieces to rest on the user's ears and a transparent medium through which the user may see.

2. The garment of claim 1, wherein the fabric is netting.

3. The garment of claim 2, wherein openings in the netting are large enough to allow for a user to breathe through while small enough to prevent objects from passing into the hood.

4. The garment of claim 1, wherein the internal frame conforms to the surface of the user's face preventing foreign objects from entering between the lenses and the user's eyes.

5. The garment of claim 1, wherein the transparent medium is polarized.

6. The garment of claim 1, further comprising a tightening device defined in the lower portion of the hood to tighten the hood close to the body of the user and prevent objects from entering into the hood.

7. The garment of claim 1, further comprising an internal hat structure to maintain the fabric a distance away from the users face.

8. The garment of claim 1, wherein the transparent medium comprises prescription lenses.

9. The garment of claim 1, wherein the transparent medium is tinted.

10. A protective hood, comprising:
a piece of fabric formed to completely cover a user's head and neck;
an eye hole defined in the hood; and
a pair of glasses coupled to the interior edges of the eye hole.

11. The protective hood of claim 10, wherein the glasses are goggles.

12. The protective hood of claim 10, wherein the hood is made of a heat retaining fabric.

13. The protective hood of claim 10, wherein the hood is made of a netting material.

14. The protective hood of claim 13, wherein openings in the netting material are large enough to allow for a user to breathe through while small enough to prevent objects from passing into the protective hood.

15. The protective hood of claim 10, wherein the hood further comprises a tightening device located at a lower portion of the hood to secure the hood around the user's neck.

16. The protective hood of claim 10, wherein the glasses are sunglasses comprising tinted and polarized lenses.

17. The protective hood of claim 10, wherein the glasses are removably coupled to the hood for substituting a pair of glasses for another pair.

18. The protective hood of claim 17, wherein the eye hole is shaped to receive a number of different sizes of glasses.

19. A method of forming a hood, comprising:
forming a piece of fabric into a conical domed shape sufficient to fit entirely over a user's head and neck;
defining an eye hole in a portion of the fabric to allow a user to view out of the fabric while wearing the hood; and
coupling a number of outer edges of a pair of glasses to the interior edges of the eye hole.

20. The method of claim 19, further comprising coupling a hat to the internal surface of hood.
